(19) United States
(12) Patent Application Publication
(10) Pub. No.: US 2013/0147352 A1
(43) Pub. Date: Jun. 13, 2013

(54) Solar powered electrical circuit integrating: Auxillaries & Lighting System

(71) Applicant: Thomas James Williams, Pasadena, CA (US)

(72) Inventor: Thomas James Williams, Pasadena, CA (US)

(21) Appl. No.: 13/507,821

(22) Filed: Jul. 31, 2012

Related U.S. Application Data
(60) Provisional application No. 61/574,384, filed on Aug. 1, 2011.

(51) Int. Cl. H05B 37/02

(52) U.S. Cl. CPC H05B 37/02
USPC 315/86

(57) ABSTRACT

Powered Electrical Circuit Integrating: Auxiliaries & Lighting System hereinafter named: SPECIALS is a Process to improve Economics and to improve Electrical-Efficiency, for Solar-Cells and/or Wind-Generators that are installed atop of Parking Garages or near Parking Garages,. for Electricity Generated to be used in either Aboveground Garages in Buildings or Underground Garages in Buildings and other areas of Building. DARK Garages' unpainted GRAY Walls, Columns, Floors, Ceilings, DARK Stairways and areas are painted with bright WHITE Paint, thereby WHITE Paint, allows a REDUCTION of Electricity used to illuminate these DARK Garages and other DARK Structures. Advertising Space such as Signage, Billboards and other Media in, around and adjacent to Parking Garage and nearby Structures maybe Rented, or Sold, in which a portion of Advertising Dollars maybe budgeted to defray cost of Solar-Cells and/or Wind Generators operations. Other benefits of SPECIALS are described herein.

### BACKGROUND OF INVENTION

Presently, the use of Solar-Cells or Photovoltaic-Cells which generate Electricity from Sunlight, are much more expensive in cost per Kilowatt-Hour, than the cost of Electricity which is generated from conventional sources of an Electric Utility Grid, such as Coal, Natural Gas or Hydro Powered. At the present time and for the foreseeable future, the cost of Solar-Cells or Photovoltaic-Cells generated Electricity far exceeds the cost of Coal, Natural Gas or Hydro Power, powered Electricity. Such Solar Power will be Clean.

Similarly, the use of Wind Powered Turbine Electric Generators or Wind-Generators which generate Electricity from blowing Wind, are much more expensive in cost per Kilowatt-Hour, than the cost of Electricity which is generated from conventional sources of an Electric Utility Grid, such as Coal, Natural Gas or Hydro Powered. At the present time and for the foreseeable future, the cost of Wind Powered Turbine Electric Generators or Wind-Generators generated Electricity far exceeds the cost of Coal, Natural Gas or Hydro Power, powered Electricity. Such Wind Power will be Clean, as opposed to other Energy. It is the purpose of this Invention to improve the Economic-Efficiency and also the Electrical-Efficiency and lower the Cost per Kilowatt Hour of said Solar-Cells or Photovoltaic-Cells, and also to improve the Efficiency and the cost per Kilowatt Hour of said Wind Powered Turbine Electric Generators or Wind-Generators, whereby Electricity generated by said Solar-Cells or said Wind-Generators, provide the Electricity to Illuminate thousands of Parking Garages in Buildings. These Parking Garages serve the needs of adjacent or nearby: Offices, Stores, Shops, Homes and other such Structures. That is also to say, WITHOUT this Invention, Electricity generated by said Solar Cells or Electricity generated by said Wind-Generators, such Kilowatt-Hours will cost considerably MORE, and said Kilowatt-Hours will be Considerably LESS Efficient in illuminating said Parking Garages in Buildings and other such Structures.

These Parking Garages in Buildings which each may have space for as few a dozen Vehicles or LESS; or said Parking Garages in Buildings each may have space for several Hundred Vehicles or MORE, maybe either: ‘Above Ground Parking Garages’ or ‘Underground Parking Garages’. Said Parking Garages may have Concrete Walls, Concrete Ceilings, Concrete Support Columns, Concrete Floors and other Concrete Areas that are DARK and GRAY in Color, and remain UN-Painted from the time of construction of the Parking Garage. Or said Walls, Ceilings, Floors and other areas of said Parking Garages maybe constructed of Masonry, Steel or other Materials that are DARK & GRAY in color, and remain UN-Painted from the time of construction of the Parking Garage. Or, the Paint has long since faded and peeled away from said Walls, Ceilings, Columns, Floors and other areas of said Parking Garages. Great amounts of Electricity are required to illuminate these DARK Parking Garages; which results in great expense to the Garage Operator or the Building Owner. The cost to Paint these DARK & GRAY Walls would be enormous. The benefit of this Invention is to cut the expense of Painting these Garages and cut the cost of Electricity from said Solar-Cells or said Wind-Generators to illuminating these Garages as described herein, by means of Electricity from Solar-Electric Cells mounted on nearby Roof-tops, or other from Electricity from nearby Wind Powered Turbine Generators or Wind-Generators.

Further improvements in Efficiencies and cost savings for said Solar-Cells or said Wind-Generators are described herein, resulting from: replacing Incandescent Lighting with either Fluorescent Lighting or LED Lighting, or replacing Fluorescent Lighting with LED Lighting or other more efficient Lighting. Free or Assigned Advertising Space for Signage and other Advertising Media can be assigned in, near or adjacent to the Parking Garages and other areas of the Building, to the Manufacturers of Suppliers of the Solar-Cells or Wind-Generators, allowing them to rebate to themselves cost savings for Advertising, that would otherwise be paid for in other Venues. Also, Advertising Space for Signage and Advertising Space for other Media in Parking, Garages or nearby or adjacent to Parking Garages or other Structures maybe Rented, Leased or Sold, with a portion of this Advertising Revenue may go to defraying the cost and expense of operation of said Solar-Cells and/or Wind-Generators. Also, Painted Parking Garages, Emergency Lighting for Parking Garages & Emergency Back-up Electric Power for Computer Mainframes, and other Improvements are detailed herein. Stairways and other areas of Buildings that have DARK & GRAY Concrete Walls, will also benefit from this Invention, as described herein.

FIGURE One, is drawn to show the Operation of this Invention.

Only, FIGURE One is submitted with this Patent Application.

Lines between Boxes are Electric Lines, carrying Electricity as required.

### SPECIALS THE PRIMARY EMBODIMENT

The Primary Embodiment of SPECIALS involves: Installing Solar-Cells aka Photovoltaic-Cells on the Rooftop of the Building of said Parking Garage, or installing said Solar-Cells nearby to said Parking Garages; generating Electrical Power which is wired to Lighting Fixtures in the nearby Parking Garage/s or other Structures, which serve the needs of nearby or adjacent: Offices, Stores, Shops, Homes and other Structures resulting in a Minimum of Electrical Loss, due to the Elimination of lengthy Electric Transmission Lines of the Electric Grid.

Whereby, painting DARK Parking Garages, either Above Ground Parking Garages or Underground Parking Garages and other Areas with Bright White Paint, results in SPECIALS provides Lighting during Daylight Hours. THEN, when the Solar Cell Power BEGINS to Fade, Electric Power from Local Electric Utility or other Provider, supplies Electric Power to Lighting Fixtures in Garage or other Areas. SPECIALS need NOT provide all Electrical Power for Lighting in Parking Garage during Daylight Hours, rather it may only provide a portion of Electric Power to illuminate Parking Garages & other Areas. Other benefits of SPECIALS includes: Further improvements in Efficiencies and cost savings for said Solar-Cells are described herein, resulting from: replacing Incandescent Lighting with either Fluorescent Lighting or LED Lighting, or replacing Fluorescent Lighting with LED Lighting or other more efficient Lighting; Free or Assigned Advertising Space for Signage and other Advertising Media in said Parking Garage or other areas of Building; or Advertising Space for Signage and other Advertising Media can be sold, rented or leased in or adjacent to Parking Garage or nearby Building; Emergency Lighting for Parking Garages & Emergency Back-up Electric Power for Computer Mainframes, and other Improvements are detailed herein. Also, Stairways and other areas of Buildings that have DARK & GRAY Concrete Walls, will also benefit from SPECIALS, as described herein.

### SPECIALS OTHER EMBODIMENTS

A Secondary Embodiment of SPECIALS involves: Installing Wind Powered Turbine

Electric Generators or Wind-Generators, on the Rooftop of the Building of said Parking Garage, or installing said Wind-Generators—nearby to said Parking Garages, generating Electricity which is wired to Lighting Fixtures in the nearby Parking Garage/s or other Structures, which serve the needs of nearby or adjacent: Offices, Stores, Shops, Homes or other Structures resulting in a Minimum of Electrical Loss, due to ELIMINATION of lengthy Electric Transmission Lines of the Utility Grid.

Whereby, painting DARK Parking Garages, either Above Ground Parking Garages or Underground Parking Garages and other Areas with Bright White Paint, results in SPECIALS providing Lighting during such time as said Windmill is in operation due to blowing wind. THEN, when the wind begins to fade, Electric Power from Local Electric Utility or other Provider, supplies Electric Power to Lighting Fixtures in Garage or other Areas. SPECIALS need NOT provide all Electric Power for Lighting in Parking Garage during times of Wind, rather it may only provide a portion of Electric Power to illuminate Garages & other Areas. Other benefits of SPECIALS includes: Further improvements in Efficiencies and cost savings for said Wind-Generators are described herein, resulting from: replacing Incandescent Lighting with either Fluorescent Lighting or LED Lighting, or replacing Fluorescent Lighting with LED Lighting or other more efficient Lighting, Free or Assigned Advertising Space for Signage and other Advertising Media in said Parking Garage or other areas of Building; or Advertising Space for Signage and other Advertising Media can be sold, rented or leased in or adjacent to Parking Garage or nearby Building; Emergency Lighting for Parking Garages & Emergency Back-up Electric Power for Computer Mainframes, and other Improvements as detailed herein. Also, Stairways and other areas of Buildings that have DARK & GRAY Concrete Walls, will also benefit from SPECIALS, as described herein.

Another Embodiment of SPECIALS involves using Electricity from the local Electric Utility Grid or other electric source to Illuminate the Light Fixtures in said Parking Garage/s or other such Structures whereby Painting DARK Garages and other Areas with Bright White Paint. Thereby, Electrical Energy is saved from Painting said Parking Garages, or other such Areas, with Bright White Paint. Other benefits of SPECIALS includes selling Advertising in said Garages, and other areas of Building or other areas nearby. Other benefits of SPECIALS are disclosed herein.

### Notes and Addendums

At the present time, there are many Parking Garages for Cars, with the Walls, Floors, Columns and Ceilings of such Parking Garages in Buildings either Above Ground Parking Garages, or Underground Parking Garages, that are NOT painted bright White. That is to say, there are many Parking Garages with the Walls and Ceilings are the natural color of unpainted GRAY Concrete. Further, many Parking Garages in Buildings either above Ground Parking Garages or Underground Parking Garages were Painted with a light Color Paint, a long time ago, and at the Present Time, such Paint has FADED, PEELED or has DISCOLORED. These Parking Garages with unpainted or faded painted

Concrete Walls, Floors, Columns and Ceilings, require MORE Electric Lighting, than such Walls and Ceilings would require if said Walls, Floors, Columns and Ceilings were painted with bright WHITE Paint. Further, many Stairways and other areas in Buildings and Structures also have Walls and Ceilings NOT painted bright White. Or, these Stairways And other areas in Buildings and Structures were painted with a light Color Paint, a long time ago, and at the Present Time such Paint has FADED, PEELED or has DISCOLORED. Again, these areas require MORE Electric Lighting, than such Walls and Ceilings would require if such areas were painted with bright WHITE Paint. SPECIALS allows Electric Energy from Solar-Electric Cells or Wind-Generators, or the local Electric Utility Grid, or from other source to be more efficient, than otherwise based on the benefits of SPECIALS described herein.

### INTRODUCTION

This Invention titled: ‘Solar Powered Electrical Circuit Integrating: Auxiliaries & Lighting System’ shall herein-after be noted as ‘SPECIALS’. This Invention is declared to be a Process Invention that makes existing Solar-Cells or Solar-Photovoltaic Cells more efficient in operation, and lower cost per Kilowatt Hour for use in illuminating Parking Garages, and other such Structures. Also, this Invention is makes existing Wind Powered Turbine Electric Generators or Wind-Generators more efficient in operations and lower cost per Kilowatt Hour for use in illuminating Parking Garages and other such Structures. conserves Energy by painting DARK Gray Walls & Ceilings of Parking Garages, Stairways and other such Structures with bright WHITE Paint, allowing LESS Electric Lighting in these painted Structures. Often, LED Lighting which is more efficient can replace Fluorescent Lighting or Incandescence Lighting. The electric energy to operate the Light Fixtures can be from nearby Solar-Electric Cells, the local Electric Utility Grid, or other Source or from nearby Wind Powered Electric Generators. Other benefits of SPECIALS are described herein.

### SPECIALS DETAILED DESCRIPTION

1. DARK Walls, Floors, Columns and Ceilings of Parking Garages for Cars and other Vehicles can be painted with bright WHITE Paint, resulting in the need for less Electric Lighting. This savings in Electric. Lighting can be gained by either removing a number of Lighting Fixtures that had been previously installed, or installing LOWER Wattage Light Fixtures in existing Fixtures. Electric Energy required to operate the Lighting inside the Parking Garage or other Structure maybe provided by Solar-Electric Cells attached to the Rooftops or nearby; or from Electricity from the local Electric Utility Grid, or other source; or such Electric Energy maybe provided by Wind Powered Turbine Electric Generators mounted on the Rooftop of the Structure, or nearby. Thereby making said Solar-Cells or said Wind-Generators or other Electrical source providing Electricity more efficient in operation, and lowering the Kilowatt-Hour costs of Electricity for said Parking Garage or other such Structure.

2. DARK Walls, Floors, Columns & Ceilings of Stairways and other such Structures can be painted with bright WHITE Paint, resulting in the need for less Electric Lighting. This savings in Electric Lighting can be gained by either removing a number of Lighting Fixtures that had been previously installed, or installing LOWER Wattage Light Fixtures in existing Fixtures. Electric Energy required to operate the Lighting inside the Garage or other Structure maybe provided by Solar-Electric Cells attached to the Rooftops or nearby; or from Electricity from the local Electric Utility Grid, or other source; or such Electric Energy maybe provided by Wind Powered Electric Generators mounted on the Rooftop of the Structure, or nearby. Thereby making said Solar-Cells or said Wind-Generators or other Electrical source providing Electricity more efficient in operation, and lowering the Kilowatt-Hour costs of Electricity for said Parking Garage or other Structure.

3. DARK Walls, Floors, Columns & Ceilings of other Buildings and Structures, whether for Vehicles, Persons or Storage can be painted with bright WHITE Paint; resulting in the need for less Electric Lighting. This savings in Electric Lighting can be gained by either removing a number of Lighting Fixtures that had been previously installed, or installing LOWER Wattage Light Fixtures in existing Fixtures. Electric Energy required to operate the Lighting inside the Tunnel or other Structure maybe provided by Solar-Electric Cells attached to the Rooftops, or nearby; or from Electricity from the local Electric Utility Grid, or other source; or such Electric Energy maybe provided by Wind Powered Electric Generators mounted on the Rooftop of the Structure, or nearby. Thereby making said Solar-Cells or said Wind-Generators or other Electrical source providing Electricity more efficient in operation, and lowering the Kilowatt-Hour costs of Electricity for said Parking Garage or other such Structure.

4. These DARK Walls, Floors, Columns & Ceilings of Parking Garages, Stairways, Stairwells, or other such Structures maybe sometimes in certain locations be illuminated during Daylight Hours by means of Natural Light, from the SUN in the Sky, nevertheless—Electrical Energy can be saved during Nighttime Hours by painting said Dark Walls, Floors, Columns & Ceilings with bright WHITE Paint. Thereby making said Solar-Cells or said Wind-Generators or other Electrical source providing Electricity more efficient in operation, and lowering the Kilowatt-Hour costs of Electricity for said Parking Garage or other such Structure.

5. White Plastic Five or Ten Gallon Buckets of Paint can be recycled into Reflectors, whereby these White Paint Buckets are sawed and cut into quadrants. Then these quadrants are connected and installed with Bushings or Brackets to the Walls and Ceilings by means of Screws and Fasteners close to Light Fixtures. Or, these White Plastic Paint Buckets maybe recycled in other ways to be used to reflect Light and increase Lighting Efficiency. Thereby, Light from the Light Fixtures can be reflected AWAY from nearby Walls that are NOT in the need of Lighting. Thereby making said Solar-Cells or said Wind-Generators or other Electrical source providing Electricity more efficient in operation, and lowering the Kilowatt-Hour costs of Electricity for said Parking Garage or other such Structure.

6. Bright Metal One Gallon Buckets of Paint can be recycled into Reflectors, whereby these Bright Metal Buckets are sawed and used as Reflectors. Then these Buckets are connected and installed with Bushings or Brackets to the Walls and Ceilings by means of Screws and Fasteners close to Light Fixtures. Thereby, Light from the Light Fixtures can be reflected AWAY from nearby Walls or Areas that are NOT in the need of Lighting. Thereby making said Solar-Cells or said Wind-Generators or other Electrical source providing Electricity more efficient in operation, and lowering the Kilowatt-Hour costs of Electricity for said Parking Garage or other such Structure.

7. Cars and other Vehicles that are painted WHITE or are painted nearly WHITE can be assigned to park in parking stalls of Parking Garages either Above ground or Underground that are directly underneath Electric Lighting Fixtures. Thereby, the Reflection of Light from the Light Fixtures upon the White Roofs, White Hoods and White Trunk Lids will result in more efficient use of Electric Lighting. Thereby making said Solar-Cells or said Wind-Generators or other Electrical source providing Electricity more efficient in operation, and lowering the Kilowatt-Hour costs of Electricity for said. Parking Garage or other such Structure.

8. Cars and other Vehicles that are painted WHITE or are painted nearly WHITE can be assigned to park in parking stalls that are ABOVE Ground in areas which receive DIRECT Light from the SUN for at least part of the Day. Thereby, the Reflection of Light from the direct light of the SUN upon the White Roofs, White Hoods and White Trunk Lids will result in more efficient use of Electric Lighting. Thereby making said Solar-Cells or said Wind-Generators or other Electrical source providing Electricity more efficient in operation, and lowering the Kilowatt-Hour costs of Electricity for said Parking Garage or other such Structure.

9. Vehicles that are painted BLACK or are painted in other DARK Colors can be assigned to park in parking stalls that are ABOVE Ground Parking Garages or Underground Parking Garages, that are FARTHEST from Electric Lighting Fixtures. Thereby, POOR Reflection of Light from the Light Fixtures upon the BLACK or DARK Roofs, BLACK or DARK Hoods and BLACK or DARK Trunk Lids will result in less impact on efficient use of Electric Lighting. Thereby making said Solar-Cells or said Wind-Generators or other Electrical source providing Electricity more efficient in operation, and lowering the Kilowatt-Hour costs of Electricity for said Parking Garage or other such Structure.

10. Vehicles that are painted BLACK, or are painted other DARK Colors can be assigned to park in parking stalls that are ABOVE Ground Parking Garages in areas which are FARTHEST from receiving DIRECT Light from the SUN. Thereby, POOR Reflection from the direct light of the SUN upon the BLACK or DARK Roofs, BLACK or DARK Hoods and BLACK or DARK Trunk Lids will result less impact on efficient use of Electric Lighting. Thereby making said Solar-Cells or said Wind-Generators or other Electrical source providing Electricity more efficient in operation, and lowering the Kilowatt-Hour costs of Electricity for said Parking Garage or other such Structure.

11. As a result of painting DARK Garages, Stairways and other Structures with bright WHITE Paint, thereby: Emergency Standby Battery Powered Lighting Fixtures installed in said Garages and Stairways and other Locations, can be reduced in Number. Or, such Emergency Standby Battery Powered Light Fixtures can be reduced in WATTAGE, resulting in longer Battery Life for the Emergency Standby Battery.

12. As a result of painting said Dark Parking Garages, Stairways and other Structures, with bright WHITE Paint, said Areas can have: Electric Timing Devices, Light Sensing Devices and other Voltage Controls installed, so that when Electric Power from Solar-Cells BEGINS to Fade near Sunset or during Cloudy Days, Lighting Fixtures will be powered from Electricity from Batteries, or from Electricity from Electric Utility Grid or from other Electric Sources.

13. As a result of painting said Dark Parking Garages, Stairways and other Structures, can have: Electric Control Devices, Light Sensing Devices and other Voltage Controls installed, so that when Electric Power from Wind-Generators BEGINS to fade during times of little Wind or low speed Wind, Lighting Fixtures will be powered from Electricity from Batteries, or from Electricity from Electric Utility Grid or from other Electric Sources.

14. It maybe necessary to use a BRIGHT WHITE Epoxy Coating or similar material as a coating for coverage on Floors of Parking Garages, Stairways and other such Structures. Such an Epoxy Coating will stand up to wear and tear of Vehicle's Tires and foot traffic, more so, than regular Paint. That is to say, Regular Paint which is either Oil Based Paint or Water Based Paint, does NOT have the TOUGHNESS to take long term wear and tear from Vehicles driving on such Paint in a Parking Garage, or scuffing from foot traffic. Thereby; use of BRIGHT WHITE Epoxy Coating or similar material for coating Floors of Parking Garages, Stairways or other such areas will make said Solar-Cells or said Wind-Generators or other Electrical source providing Electricity more efficient in operation, and lowering the Kilowatt-Hour costs of Electricity for said Parking Garage or other Structure.

15. In the event, that the Walls, Columns and Ceilings of the Parking Garage, Stairway or other such area are painted with BRIGHT White Paint, most often the Floors of Parking Garage, Stairway or other such area was left UN-Painted, and is Dark Gray in Color. Therefore, efficiency of SPECIALS can be increased by Painting the Floors of said Parking Garages, Stairways or other such areas with BRIGHT White Epoxy Coating or similar materials for the purpose of further increasing the efficiency of the Lighting and lowering the cost per Kilowatt Hour of Electricity.

16. Suppliers and/or Manufacturers of the Solar-Cells, or their Corporate Affiliates of said Suppliers and/or Manufacturers of said Solar-Cells, can be assigned FREE Advertising Signage in said Parking Garage, Stairway or other part of the Building either inside or outside of the Building of the Parking Garage or other such area of that Building, to promote their Business and Solar-Cells for sale, or to promote the Business of their Corporate Affiliates of said Suppliers and/or Manufacturers of said Solar-Cells. In effect, such Free Advertising, can be charged as an Income to the Supplier and/or Manufacturer of said Solar-Cells, to LOWER the Cost of Solar-Cells, thereby improving the Economic Efficiency of said Solar-Cells. Whereby, Advertising Budget of said Suppliers and/or Manufacturers of said Solar-Cells or the Advertising Budget of their Corporate Affiliates of said Suppliers and Manufacturers of said Solar-Cells, that was BUDGETED to be spent on other MEDIA in any event, is then spent to lower the cost of Solar-Cell's installation and operation.

That is to say, Suppliers and/or Manufacturers of said Solar-Cells or their Corporate Affiliates, who previously spent their Advertising Budget in other Media, such as Billboards, Newspapers, Radio and TV; can re-direct their Advertising Budget to pay for part of the expense of Solar-Cells in Parking Garage, Stairway or other areas of the Building either inside the Building or outside the Building. Thereby making said Solar-Cells providing Electricity more efficient in operation, and lowering the Kilowatt-Hour costs of Electricity for said Parking Garage, Stairway or other such Structure.

17. Suppliers and/or Manufacturers of the Wind-Generators or their Corporate Affiliates of said Suppliers and/or Manufacturers of said Wind-Generators, can be assigned FREE Advertising Signage in said Parking Garage; Stairway or other part of the Building either inside or outside of the Building of the Parking Garage or other such area of that Building, to promote their Business and Wind-Generators for sale, or to promote the Business of their Corporate Affiliates of said Suppliers and/or Manufacturers of said Wind-Generators. In effect, such Free Advertising, can be charged as an Income to the Supplier and/or Manufacturer of said Wind-Generators, to LOWER the Cost of Wind-Generators thereby improving the Economic Efficiency of said Wind-Generators. Whereby, Advertising Budget of said Suppliers and/or Manufacturers of said Wind-Generators or the Advertising Budget of their Corporate Affiliates of said Suppliers and Manufacturers of said Wind-Generators that was BUDGETED to be spent on other MEDIA in any event, is then spent to lower the cost of Wind-Generators installation and operation. That is to say, Suppliers and/or Manufacturers of said Wind-Generators or their Corporate Affiliates, who previously spent their Advertising Budget in other Media, such as Billboards, Newspapers, Radio and TV, can re-direct their Advertising Budget to pay for part of the expense of Wind-Generators in Parking Garage, Stairway or other areas of the Building either inside the Building or outside the Building. Thereby making said Wind-Generators providing Electricity more efficient in operation, and lowering the Kilowatt-Hour costs of Electricity for said Parking Garage, Stairway or othersuch Structure.

18. Suppliers and/or Manufacturers of Paint, Floor Epoxy Coating and other Painting Supplies, or their Corporate Affiliates of said Suppliers and/or Manufacturers of said Paint and Supplies, can be assigned FREE Advertising Signage in said Parking Garage, Stairway or other part of the Building either inside or outside of the Building of the Parking Garage or other such area of that Building, to promote their Business of Paint and Supplies for sale, or to promote the Business of their Corporate Affiliates of said Suppliers and/or Manufacturers of said Paint and Supplies. In effect, such Free Advertising, can be charged as an Income to the Supplier and/or Manufacturer of said Paint and Supplies, to LOWER the Cost of Paint & Supplies, thereby improving the Economic Efficiency of said Paint and Supplies. Whereby, Advertising Budget of said Suppliers and/or Manufacturers of said Paint and Supplies or the Advertising Budget of their Corporate Affiliates of said Suppliers and Manufacturers of said Paint and Supplies, that was BUDGETED to be spent on other MEDIA in any event, is then spent to lower the cost of said Paint and Supplies. That is to say, Suppliers and/or Manufacturers of said Paint and Supplies or their Corporate Affiliates, who previously spent their Advertising Budget in other Media, such as Billboards, Newspapers, Radio and TV, can re-direct their Advertising Budget to pay for part of the expense of Paint and Supplies in Parking Garage, Stairway or other areas of the Building either inside the Building or outside the Building. Thereby making said Paint and Supplies more efficient in costs, and lowering the Kilowatt-Hour costs of Electricity for said Parking Garage, Stairway or other such Structure.

19. Suppliers and/or Manufacturers of Materials such as Wiring, Electrical Controls and other Equipment, or their Corporate Affiliates of said Suppliers and/or Manufacturers of said Wiring, Controls and other Equipment, can be assigned FREE Advertising Signage in said Parking Garage, Stairway or other part of the Building either inside or outside of the Building of the Parking Garage or other such area of that Building, to promote their Business of Wiring, Controls or other Equipment for sale, or to promote the Business of their Corporate Affiliates of said Suppliers and/or Manufacturers of said Wiring, Controls and Equipment. In effect, such Free Advertising, can be charged as an Income to the Supplier and/or Manufacturer of said Wiring, Controls and Equipment to LOWER the Wiring, Controls and Equipment, thereby improving the Economic Efficiency of said Wiring, Controls and Equipment. Whereby, Advertising Budget of said Suppliers and/or Manufacturers of said Wiring, Controls and Equipment or the Advertising Budget of their Corporate Affiliates of said Suppliers and Manufacturers of said Wiring, Controls and Equipment, that was BUDGETED to be spent on other MEDIA in any event, is then spent to lower the cost of said Wiring, Controls and Equipment. That is to say, Suppliers and/or Manufacturers of said Wiring, Controls and Equipment or their Corporate Affiliates, who previously spent their Advertising Budget in other Media, such as Billboards, Newspapers, Radio and TV, can re-direct their Advertising Budget to pay for part of the expense of Wiring, Controls and Equipment for said Parking Garage, Stairway or other areas of the Building either inside the Building or outside the Building. Thereby making said Wiring, Controls and Equipment more efficient in costs, and lowering the Kilowatt-Hour costs of Electricity for said Parking Garage, Stairway or other such Structure.

20. Thereby, said Manufacturers or Suppliers of said: Solar-Cells, Wind-Generators, Paint, Wiring, Electrical Controls and other Equipment and Supplies, OR their Corporate Affiliates, can claim some or all of the Electrical Energy generated by Solar-Cells or Wind-Generators to meet some or all of present or future Government Requirements or self imposed Corporate Regulations to replace Fossil-Fueled Electricity with Alternate Energy forms of Electricity as from said Solar-Cells or Wind-Generators.

21. Those Corporations or other Entities that Rent, Lease or Own said Parking Garages, Stairways or other such areas; or said Corporations or other Entities that Rent, Lease or Own the nearby or adjacent: Offices, Stores, Shops or other Structures that are served by said Parking Garages, Stairways and other areas, may also choose to Rent Space for Advertising in either said Parking Garages, Stairways or in or outside of said Building.

Whereby, the Money spent by the Corporation or other Entity on said Advertising in said Parking Garage, Stairways, other areas or in or outside of the Building in forms of Signage, Billboards, Video Media, or other forms of Media, is used to pay for the purchase of said Solar-Cells or Wind-Generators, and their associated Electrical Controls Devices and Hardware. Thereby, said Corporations or other Entities, or their Corporate Affiliates can claim some or all of the Electrical Energy generated by Solar-Cells or Wind-Generators to meet some or all of present or future Government Requirements or self imposed Corporate Regulations to replace Fossil-Fueled Electricity with Alternate Energy forms of Electricity as from said Solar-Cells or Wind-Generators. The Advertising Space including Signage, Billboards and other Media in and around and adjacent to said Parking Garages and other such Structures may also be Rented, Leased or Sold to other Corporations or other Entities that are NOT normally parking vehicles in said Parking Garages, whereby said Corporations or other Entities can then claim all or a portion of the Energy generated by said Solar-Cells and/or Wind-Generators to meet their requirements for Alternate Energy and or Pollution Free generated Electricity.

22. The Electrical Energy for this Invention, need NOT be limited to be generated from Solar-Cells, NOR limited to Wind-Generators. Rather other forms of Electrical Energy can be substituted for this Invention such as: Fuel Cells Electrical Generation, Electrical Battery Storage and Generation of Electricity, Flywheel Electrical Storage and Generation of Electricity, Compressed Air Storage and Generation of Electricity, and other forms of Electrical Generation and/or Electrical Storage and Generation. In the event the Electrical Generation comes from an Electrical Storage Device such as Battery, Flywheel or Compressed Air, then the Electrical Storage Device will discharge Electricity during the Day, when Electrical Rates are highest. Then, during Off-Peak Hours the Electrical Storage Devices will be RE-Charged with Electricity from the Utility Grid, or other Electrical Supply, when Electric Rates are lowest. These Devices: Fuel Cells, Batteries, Flywheels, Compressed Air Systems, or other such Devices can be installed in the Building of said Parking Garage, Stairways or other such area, or such Devices can be installed NEAR to said Building, thereby cutting electrical losses and need for expensive Electrical Switching Equipment and Electrical Control Equipment.

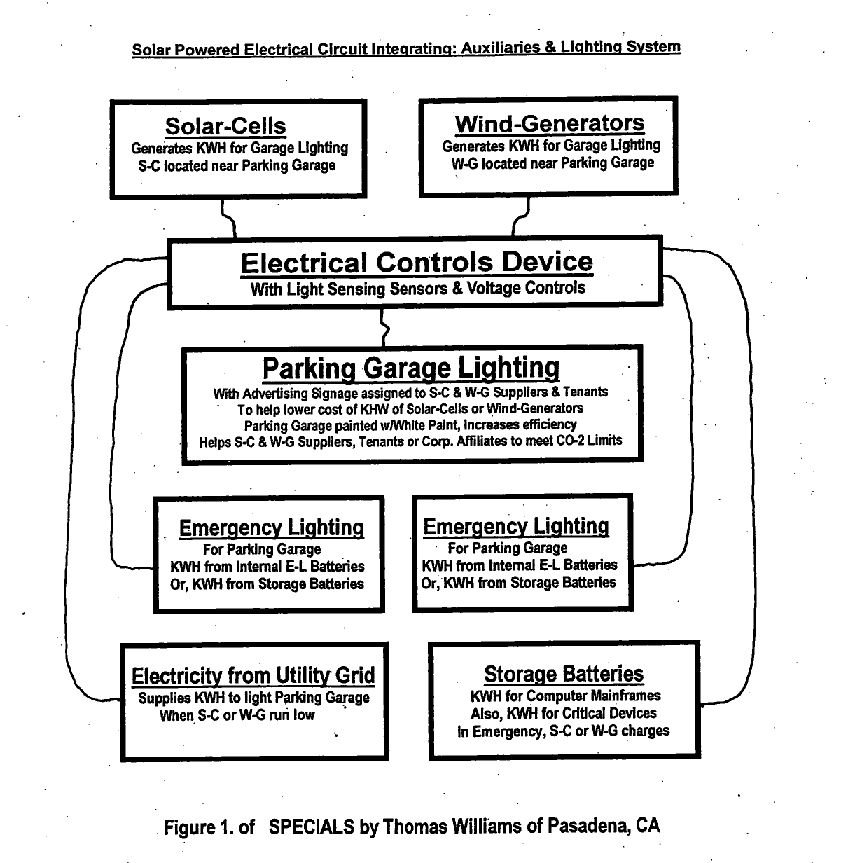

23. SEE FIG. 1. In the Event, that Electric Power from the Electric Utility Grid is LOST or SHUT-OFF to the Offices, Stores, Warehouse, Shops or other Structures, that are served by said Parking Garage/s, Stairways and other such areas, which are supplied Electricity by Solar-Cells or Wind-Generators; then at that time, by means of Electrical-Control Devices, or by Manual Controls, the Electricity from said Solar-Cells or Wind-Generators can be directed to supply Electricity to Computer Mainframes and other Critical Electrical Devices of said Offices, Stores, Homes, Shops or other Structures. Structures. Said Electricity generated from said Solar-Cells or said Wind-Generators can be sent thru said Electrical Control Device to DIRECTLY operate said Mainframe Computers and other Critical Electrical Devices. Or, said Electricity generated from said Solar-Cells or said Wind-Generators can be sent thru said Electrical Control Device to Electrical Storage Batteries, which provide Emergency Back-up Power to said Computer Mainframes or other Critical Electrical Devices.

24. SEE FIG. 1. At such time, that the Electric Power from the Event detailed in Paragraph 21 occurs, the PRIMARY Electric Lighting to said Parking Garages, Stairways and other such areas will be LOST or SHUTDOWN. At that time, the Emergency Electric Lighting in said Parking Garages, Stairways and other such areas will be turned on by said Electrical Control Device. The Electric Power for said Emergency Electric Lighting in said Parking Garages, Stairways and other such areas maybe supplied by Individual Batteries to each Emergency Electric Lighting Fixture, or several Emergency Electric Lighting Fixtures maybe supplied by electric connection to ONE Electric Battery. Or some, or all of the Emergency Electric Lighting Fixtures can be connected to one or more of the Batteries that supply Electric Power to Computer Mainframes or the Batteries of other Critical Electrical Devices.

25. SEE FIG. 1. At such times that said: Offices, Stores, Shops, and other such Structures are closed on Weekends, Holidays or other such Days, it maybe possible to Close or Shutdown said Parking Garages, Stairways and other such Areas, allowing Emergency Lighting to provide a minimum level of Lighting, by means of said Electrical Control Device. At such times, it maybe possible to SELL Surplus Power from said Solar-Cell or Wind-Generator by means of said Electrical Control Device to said Electric Utility for use elsewhere.

26. SEE FIG. 1. At such times that Sunlight is too WEAK due to Cloudy Weather or times of Year to NOT provide enough Light Energy to operate said Solar-Cells, it maybe necessary to BUY Electric Power from said local Electric Utility or other Electric source, by means of said Electrical Control Device.

27. SEE FIG. 1. At such times that Wind Speed is too SLOW due to calm conditions, to NOT provide enough Wind Energy to operate said Wind-Generators, it maybe necessary to BUY Electric Power from said local Electric Utility or other Electric source, by means of said Electrical Control Device.

28. This Invention, known as SPECIALS does NOT claim to provide all of the Electrical Power from Solar-Cells or Wind-Generators to operate large and multi-story Buildings which may contain: Offices, Stores, Shops, Homes or other such Structures. Rather that is to say, this Invention limits its Claims to providing some, most or maybe all of the Electric Power required for Lighting in said Parking Garages, Stairways and other such areas, by means which increased Economic-Efficiency and increased Electrical-Efficiency of said Solar-Cells or Wind-Generators that are adjacent or near said Parking Garages, Stairways and other such areas as described herein.

1. ‘Solar Powered Electrical Circuit Integrating: Auxiliaries & Lighting System’ hereinafter referred to as: SPECIALS is a New and Useful Process to improve Economic-Efficiency and improve Electrical-Efficiency, and lower operating expenses for Solar-Cells and/or Wind-Generators that are installed atop of Parking Garages or near said Parking Garages, for such Electrical Energy to be used in Parking Garages of Buildings, of either Above-ground Parking Garages in Buildings or Under-ground Parking Garages in Buildings and other such areas of said Building;
whereby such DARK Parking Garages of unpainted GRAY Concrete Walls, Columns, Floors, Ceilings, DARK Stairways and areas are painted with bright WHITE Paint, thereby painting with WHITE Paint, allows a REDUCTION of Electric Energy which is used to illuminate these DARK Garages and other DARK Structures;
whereby existing lighting fixtures in said Parking Garages may have a large number of Light Bulbs or Light Tubes removed, to improve Efficiency, once said Parking Garage is painted with bright WHITE Paint;
whereby often, LED's known as ‘Light Emitting Diodes’ with HIGH Efficiency of converting Watts to Lumens, can replace existing Fluorescent Lighting or Incandescence Lighting;
whereby Free or Assigned Advertising Space in these brightly painted Garages, or inside or outside of said Building of said Parking Garage can be assigned to Suppliers and/or Manufacturers of said Solar-Cells and/or Wind-Generators, and Paint and other Supplies and Equipment, which, may pay a portion of the cost of the installation and lower the cost per Kilowatt-Hour of operations of Solar-Cells and/or Wind-Generators, where otherwise, said Manufacturers and Suppliers would spend their Advertising Budget in other Venues;
whereby other Advertising Space such as Signage, Bill-boards and other Media in, around and adjacent to Parking Garage and nearby Structures maybe Rented, Leased or Sold, in which a portion of these Advertising Dollars maybe budgeted to defray the cost of said Solar-Cells and/or Wind-Generators operations;
whereby one or more Electrical Controls Devices with light sensing sensors and voltage controls maybe installed to control the source of Electricity from Solar-Cells and/or Wind-Generators and/or Local Electric Utility and/or other Electrical Generating Source for use in said Parking Garages or other such Structures for the most efficient usage of Electricity;
whereby one or more Electric Storage Batteries maybe used to supply Electricity in event of Emergency or supply Electricity in due to other disruptions of Electricity.

2. Said Solar-Cells in claim One, maybe any variety of type of Solar-Cells which convert Sunlight into Electricity, whether of different chemical compositions, methods of manufacture, whether such Solar-Cells or concentrating of Sunlight or NON-concentration of Sunlight.

3. Said Wind-Generators in claim One, maybe any variety of type of Wind-Generators, which convert Wind into Electricity, whether such Wind-Generators are of different types of construction or different types of operation.

4. Said Solar Cells and/or Wind-Generators in claim One, maybe replaced as an Electrical Energy Source for this Invention by means of: Fuel Cells, Compressed Air Storage, Flywheel Energy, or other Energy Source which maybe located in said Parking Garage or near or adjacent to said Parking Garage or other such nearby Structure or Structures.

5. Said Paint in claim One, maybe any variety of type of Paint, including Oil Based Paint, Water Based Paint, Epoxy Coatings or other variety of Paints or Coatings which is used to paint and cover the walls of said Parking Garages or other such Structures, for the purposes of making said Walls of said Parking Garages—both brighter and whiter allowing less Illumination to be needed.

6. Said Electrical Controls Device or Electrical Controls Devices as in claim One, maybe of any type of construction and operation, which allows for the most efficient use of Electricity as conditions change for said Solar-Cells, Wind-Generator, other Energy Source located adjacent as stated in claim Four, or from Local Electric Utility.

7. Said Electrical Controls Device or Electrical Controls Devices as in claim Six, may also include a variety of Light Sensing Sensors, which maybe installed in a number of locations in said Parking Garages or other such Structures, these said Light Sensing Sensors are in communication with said Electrical Controls Device for the most efficient operation of this Invention, in selecting the source of Electricity for use in said Parking Garages and other such Structures.

8. Said Voltage Controls of said Electrical Controls Devices as in claim Six, provide for the Switching of Electrical Supply from either Electricity generated in said Parking Garages or adjacent to said Parking Garages or said Voltage Controls provide for the Switching of Electrical Supply from Electricity generated from the Local Electric Utility or from other source of Electricity as is required to operate this Invention.

9. Said Electrical Control Device or Electrical Control Devices allow for Electric powered Lighting to said Parking Garages or other such Structures to be adjusted to different levels of Illumination based on Emergency Requirements and when Vehicle Traffic is minimal as on Weekends, Holiday and other times as required.

10. Said Electric Storage Batteries in claim One, maybe any type of Battery, including but not limited to: Lead-Acid Batteries, Lithium Batteries, Metal-Hydride Batteries, or any other type of Electric Batteries or other type Electric Storage Devices, with such Batteries or other Storage Devices being of any number of Voltages for the operation of this Invention.

11. Said Electric Storage Batteries in claim Ten, maybe located at One location in said Parking Garages or nearby to said Parking Garages or other such Structures to provide Emergency Electric Power, or said Electric Storage Batteries maybe located in a number of locations in said Parking Garages or nearby to said Parking Garages or other such Structures to provide Emergency Electric Power.

12. In Reference to claim Nine, Said Electric Storage Batteries being controlled by said Electrical Controls Devices, may have in an Emergency, Electric Power diverted in whole or in part to operate Critical Electrical Devices in Building adjacent or nearby to said Parking Garages, for the purpose of providing Electricity to Mainframe Computers, Communications Equipment, Emergency Lighting in said Building, thereby requiring Electrical Energy to said Parking Garages and other such Structures to be operated on a Minimal level of Electricity for purposes of Illumination of said Parking Garages and other such Structures from said Electric Storage Batteries.

13. Said Electrical Control Devices may allow Electricity when generated in Surplus from said Solar-Cells or said Wind-Generator to be diverted from said Parking Garages and other such Structures, to be sold to the Local Electric Utility or sold to others.

14. In reference to claim Thirteen, such as on Weekends, Holidays or other Days, when only minimal Electricity is required to illuminate said Parking Garages and other such Structures, due to a minimum of Vehicle Traffic, it maybe possible to divert surplus Electricity generated from said Solar-Cells and/or said Wind-Generators to be sold to the Local Electric Utility or sold to others.

15. Said Advertising Space in said Parking Garages, adjacent to said Parking Garages or nearby to said Parking Garages or other such Structures may include but is NOT limited to: Signage, Billboard, Electronic Media, Showroom Models of Products placed in Walkways or Lobbies and all other types of Media and Medium.

16. Said Advertising Space as referenced in claim Fifteen, maybe assigned at NO charge, or at a Reduced Charge or at Regular Advertising Rates to Manufacturers, Suppliers and Contractors of: Solar-Cells, Wind-Generators, Paint, Electrical Control Devices and other Equipment and Supplies required to install and operate this Invention, thereby allowing such Manufacturers, Suppliers and Contractors to reduce their Costs, Prices and Charges for such Equipment and Supplies installed in said Parking Garages, adjacent to said Parking Garages or nearby to said Parking Garages or other such Structures.

17. Said Advertising Space as referenced in claim Fifteen, maybe assigned at NO charge, or at a Reduced Charge or Regular Advertising Rates to. Tenants, Leaseholders, Owners and others who park their Vehicles in said Parking Garages, whereby said Tenants, Leaseholders, Owners and others can then claim a portion or all of the Electricity generated by said Solar Cells and/or Wind-Generators to meet requirements for generating Electricity from Alternate and/or Pollution-Free sources, thereby allowing all or a portion of the Revenue from said Advertising to reduce their Costs, and charges of Electricity generated from said Solar-Cells and/or Wind-Generators.

18. Said Advertising Space as referenced in claim Fifteen, maybe assigned at NO charge, or at a Reduced Charge or Regular Advertising Rates to Corporations and other Entities who wish to Advertise and are NOT: Tenants, Leaseholders, Owners or others in said Parking Garages, so that said Corporations and other Entities can then claim a portion, or all of the Electricity generated by said Solar Cells and/or Wind-Generators to meet requirements for generating Electricity from Alternate and/or Pollution-Free sources, thereby allowing all or a portion of the Revenue from said Advertising to reduce their Costs, and charges of Electricity generated from said Solar-Cells and/or Wind-Generators.

19. Vehicles that are White in Color or nearly White in Color can be assigned to Park in areas in said Parking Garages that are underneath Light Fixtures attached to Ceilings, Walls or other Structures; or. said Vehicles that are White in Color or nearly White in Color can be assigned to Park in areas that are NEAR Light Fixtures attached to Ceilings, Walls or other Structures, thereby allowing said Vehicles to increase the efficiency of said Lighting Fixtures.
